(19) United States
(12) Patent Application Publication
(10) Pub. No.: US 2008/0036846 A1
(43) Pub. Date: Feb. 14, 2008

(54) Animal Identification Marking

(76) Inventors: Donald Leslie Hopkins, Palmerston North (NZ); John Clifford Rutherford, Maunganul (NZ)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/596,531

(22) PCT Filed: May 13, 2005
(86) PCT No.: PCT/NZ05/00098

§ 371 Date: Nov. 13, 2006

(30) Foreign Application Priority Data
May 14, 2004 (NZ) 532931

(51) Int. Cl. B41J 2/435

(52) U.S. Cl. 347/224

(57) ABSTRACT

A method for making an animal identification label. The method includes the steps of heating a surface of the label to thereby create a gloss surface thereon. Indicia marking and/or printing is then applied.

### BACKGROUND TO THE INVENTION

This invention relates to improvements in animal identification marking.

Visual identification of an animal by a label carried on the animal is well known. Most commonly the label is in the form of a tag which, in use, is applied to the ear of the animal.

The so-called ear tag has a panel portion on which identification indicia is marked. The indicia can be marked by hot foil stamping or laser ink printing on the surface of the tag or can be marked into the tag by laser marking.

Because the identification indicia is normally read at a distance it is desirable that the indicia contrasts with the colour of the panel and has permanency.

An advantage of laser marking is that it is permanently imbedded in the tag but contrast with the background material of the tag is generally not as stark as with laser ink printing or hot foil stamping.

A problem with hot foil stamping is that the laser ink printing can deteriorate over time. One of the reasons for this is that in use abrasive contact can occur with the panel surface thereby resulting in the marking deteriorating. This deterioration can occur to the point of the indicia being difficult to read or in extremes cases, worn away either in part or entirely.

In WO 98/48398 there is described a procedure whereby a tag is marked with laser marking and at least some of the laser marking overprinted by laser ink printing or hot foil stamping. In this way good contrast can be achieved but if any of the surface printing (laser ink or hot foil) is worn away or deteriorates, the laser marking becomes visible, hence retaining the important indicia on the tag.

A further problem with animal ear tags, which can reduce the ability to easily read the identification indicia, is caused by the indicia bearing surface of the tag becoming dirty. The environment in which the ear tag is used can often result in extraneous material coming into contact with and adhering to the identification area of the tag.

With modern day ear tags, it is common for the tag to be manufactured with the surface of the tag matt or slightly rough in texture. This aids in adhesion or keying of the printed indicia on the surface of the tag. However, the matt or slightly rough texture increases the risk of extraneous material, dirt etc adhering to the tag surface, thus, impairing the contrast between indicia and background colours of the tag or visibility of the indicia.

### SUMMARY OF THE INVENTION

An object of the present invention is to provide an animal identification label marking system, which goes some way to providing an indicia bearing surface to which surface dirt or extraneous material is less likely to adhere or become attracted to.

Broadly according to one aspect of the present invention there is provided a method for marking an animal identification label, the method including the steps of heating a surface of the label to thereby create a gloss surface thereon and then applying indicia marking and/or printing to the surface.

In a preferred form of the invention the indicia is applied when the surface still retains residual heat form the heating process.

In a preferred form of the invention the surface is permitted to cool following which laser marking is used to apply the indicia.

In a preferred form of the invention the surface while still retaining residual heat has indicia applied thereto by laser marking and then at least some of this indicia is overmarked with laser ink printing.

In the preferred form of the invention the heating of the surface is achieved by bringing a heated surface into contact with the said surface of the label.

In the preferred form of the invention the heated surface makes contact with the surface of the label under pressure. This can, according to one form of the invention, be achieved by use of a press.

### DESCRIPTION OF PREFERRED EMBODIMENT OF THE INVENTION

In accordance with known animal identification labels and more particularly animal identification ear tags, the tag incorporates a panel on which identification indicia can be applied. As mentioned above, the method of application of the indicia can vary and can include hot foil stamping or laser printing onto the surface of the tag or laser marking into the tag substrate. All of this is in accordance with known animal identification technology and does not require further description for the purposes of the present invention.

According to the present invention an animal identification label such as an ear tag has a surface on which the identification indicia can be applied. The tag or more particularly the part of the tag having the surface on which identification indicia will be applied is heated. This can be achieved by the tag part located within a press device.

According to one arrangement the indicia bearing portion of the tag can be located on an anvil. A heated block is then moved into contact with the portion of the tag on the anvil and is held there for about two seconds. The block is heated to about 200° C. before being pressed onto the surface of the portion of the tag.

After the aforesaid two-second period the heated block is retracted away from the tag and the tag is released from the press. The surface of the tag with which the heated plate has been in contact will have a gloss surface.

In a commercial form of the system a plurality of tags are delivered to the press by way of a conveyor. The tags are placed on a trolley on the conveyor, this trolley moving into and stopping within the press. In the preferred form of the invention the press is pneumatically operated.

The heated block then comes down and engages the uppermost or exposed surface of the tags on the trolley for about two seconds. The trolley of tags, which has just been heated by the heated block, is released from the press and continues onto a printing station.

In the preferred form of the invention the heating of the surface on which the indicia is to be marked, is heated to a temperature to melt the surface and thereby achieve the gloss finish. While it is preferred that that temperature be in the order of 200° C. temperatures either side of this, which achieve the gloss finish, but without any damage to the tag can be used. Such damage, could for example, arise from the tag surface being burnt or the melting being excessive.

In a preferred form of the invention the material of the tag to the side of the tag opposite that of the surface on which the indicia is to be marked, can also be heated but to a lesser temperature than that of the surface on which the indicia is to be applied. In this way the tag panel can be prevented from curling i.e. the tag panel is kept flat.

To enhance the gloss finish of the tag surface, the heated plate or block can be provided with a gloss finish.

According to an alternative arrangement, a gloss paper can be located between the heated block and the tag surface. Once the heated block has retracted, the gloss paper can be replaced by a new section of gloss paper. Thus, in one form of the invention, the gloss paper can be in roll form so that after a tag has been heated, the roll of gloss paper can be wound on i.e. indexed, so that a new section of gloss paper is ready for the next tag or quantity of tags to be heated.

According to one form of the invention, the tag after being heated to achieve the gloss surface is left to cool. The cooling can be back to ambient temperature or could be to a temperature significantly less than the temperature achieved during the melting of the tag surface to achieve the gloss surface. The thus cooled tag can then undergo laser marking to apply indicia to the tag.

In another form of the invention, indicia is applied to the tag immediately after the heating step. Thus, the indicia is applied while the tag is still above ambient temperature.

In a preferred form of the invention, the indicia can be applied by laser ink printing. In a more preferred form of the invention the indicia is applied by laser marking followed by at least some of the laser marked indicia being overprinted by laser ink printing.

The process according to the present invention can take place at some time after manufacture of the tag or could occur more or less immediately after manufacture of the tag. According to this process, the tag would be moulded and then passed to the heating press for application of the gloss surface. Following this, the tag could either be left to cool for laser marking to take place at some later time or could immediately have indicia applied thereto by laser ink printing or a combination of laser marking and laser ink printing.

The time between moulding of the tag and application of the heated block to create the gloss surface may need to involve a period of time such that the melting of the surface of the tag does not have any adverse affect on the tag as a whole. Thus, there might need to be a period of time (which tests and experience will determine) between moulding of the tag and the application of heat to the surface of the panel of the tag in order to apply the gloss surface.

The invention will is open to modification as will be appreciated by those skilled in the art. For example, the heated block or in the case of use of the gloss paper, could be provided with a non-stick surface so as to ensure that no sticking occurs between the block and the tag.

Also as will be appreciated by those skilled in the art, the heating to melt the surface of the tag could take place using means other than a heated block. For example, the heating could be applied by way of air directed onto the surface of the tag on which the indicia will be applied.

In the preferred form of the invention the material of the tag to the side of the tag opposite that of the surface on which the indicia is to be marked, can also be heated but to a lesser temperature than that of the surface on which the indicia is to be applied.

It will be appreciated by those skilled in the art that control gear will be provided for indexing of each trolley of tags into the press and released therefrom. The control gear will also provide for control of the heating of the block and the time during which the heated block stamps the marked surface of the tags on the trolley. The necessary pressure applied to the tag will also be controlled by the control gear.

The aforementioned process results in the tags or at least that part of the tags, which bear identification indicia being provided with a gloss finish. This gloss finish aids in marking retention as well as keeping the tag clean when in use. Also the gloss finish ensures a good clear contrast between the indicia and the background material of the tag during use of the tag.

It has also been surprisingly discovered that the process leads to increased adhesion of the laser ink printing. This is of a beneficial effect as it leads to increased abrasion resistance thereby resulting in longer life of the printed indicia.

Furthermore, the laser marked indicia is enhanced as it takes on more contrast with the background colour of the tag.

The preceding description of the invention according to its different forms is by way of example only. It will be appreciated by those skilled in the art that modifications or improvements might be made without departing from the scope of the invention.

What is claimed is:

1. A method for marking an animal identification label, the method including the steps of heating a surface of the label to thereby create a gloss surface thereon and then applying indicia marking and/or printing to the surface.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The method of claim 1 wherein the heating of the surface of the label is achieved by bringing a heated surface into contact with said surface of the label.

22. The method of claim 1 wherein the heating of the surface of the label is by application of heated air directed onto the surface of the label.

23. The method of claim 21 or 22 wherein the indicia is applied when the surface of the label still retains residual heat form the heating process.

24. The method of claim 21 or 22 wherein the surface of the label is permitted to cool following which laser marking is used to apply the indicia.

25. The method of claim 21 or 22 wherein the surface of the label while still retaining residual heat has indicia applied thereto by laser marking and then at least some of this indicia is overmarked with laser ink printing.

26. The method of claim 21 wherein the heated surface makes contact with the surface of the label under pressure.

27. The method of claim 26 wherein the contacting of the heated surface and surface of the label is achieved by use of a press.

28. The method of claim 27 wherein the part of the label having the surface on which indicia is to be placed is located on an anvil, a heated block is moved into contact with said part of the label on the anvil and is held there for a suitable period of time in the order of about two seconds.

29. The method of claim 27 wherein the heated surface is at a temperature of about 200° C. prior to contacting the surface of the label.

30. The method of claim 29 wherein a plurality of labels are placed on a trolley on the conveyor and then moved on the trolley into the press.

31. The method of claim 21 wherein the heated surface is provided with a gloss finish.

32. The method of claim 28 wherein a gloss paper is located between the heated surface block and the surface of the label during heating of the surface of the label.

33. The method of claim 1 wherein the material of the label to the side of the label opposite that of the surface on which the indicia is to be marked, is also heated but to a lesser temperature than that of the surface on which the indicia is to be applied.

34. The method of claim 24 wherein the cooling is to ambient temperature or a temperature significantly less than the temperature achieved during the heating of the surface of the label.

35. The method of claim 21 or 22 wherein the indicia is applied by laser marking.

36. The method of claim 35 wherein at least some of the laser marked indicia is overprinted by laser ink printing.

37. The method of claim 1 wherein the surface of the label is heated substantially following the moulding of the label following which the label is either left to cool for marking to take place at some later time or could immediately have indicia applied thereto.

38. The method of claim 31 wherein the heated surface is provided with a non-stick surface.

39. The method of claim 32 wherein the gloss paper is provided with a non-stick surface.
